(19) United States
(12) Patent Application Publication
(10) Pub. No.: US 2024/0300354 A1
(43) Pub. Date: Sep. 12, 2024

(54) VEHICLE CHARGING FACILITY

(71) Applicant: TOYOTA JIDOSHA KABUSHIKI KAISHA, Toyota-shi (JP)

(72) Inventor: Yuki WAKIDA, Toyota-shi (JP)

(73) Assignee: TOYOTA JIDOSHA KABUSHIKI KAISHA, Toyota-shi (JP)

(21) Appl. No.: 18/582,220

(22) Filed: Feb. 20, 2024

(30) Foreign Application Priority Data
Mar. 7, 2023 (JP) 2023-034954

(51) Int. Cl. B60L 53/302; B60L 53/16; B60L 53/18; B60L 53/62; H02J 7/00

(52) U.S. Cl. CPC B60L 53/302; B60L 53/16; B60L 53/18; B60L 53/62; H02J 7/0042; H02J 7/007192

(57) ABSTRACT

A vehicle includes a charging cable, an electric power equipment, a cooler, and a controller. The charging cable includes a charging connector plugged into a charging inlet of an electric vehicle. The electric power equipment supplies a charging current to a battery via the charging connector and the charging cable. The cooler cools the charging connector and the charging cable. The controller is programmed to control the cooler so as to cool the charging connector and the charging cable when the charging current is supplied from the electric power equipment to the battery. Further, the controller is programmed to limit at least one of the charging current and a charging time of the battery based on a temperature of at least one of the charging connector and the charging cable when an abnormality occurs in the cooler.

### CROSS-REFERENCE TO RELATED APPLICATION

The present disclosure claims priority to Japanese Patent Application No. 2023-034954 filed on Mar. 7, 2023, which is incorporated herein by reference in its entirety including specification, drawings and claims.

### TECHNICAL FIELD

The present disclosure relates to a vehicle charging facility for externally charging a battery of an electric vehicle.

### BACKGROUND

The conventionally known vehicle includes an inlet into which a connector of a charging cable from a charging facility is inserted, a battery charged by current supplied from the charging facility via the charging cable, and a controller that controls the current such that the current from the charging facility does not exceed a maximum allowable current (as described in, for example, Japanese Patent Application Laid Open No. 2019-187035). In this vehicle, the controller determines whether the charging facility includes a cooler for cooling the connector and the inlet. When the charging facility includes the cooler, the controller increases the maximum allowable current compared to when the charging facility does not include the cooler. This shortens a charging time of the battery in charging facilities that include the cooler.

### CITATION LIST

### Patent Literature

PTL 1: JP2019-187035

### SUMMARY

However, when the maximum allowable current in the charging facility that includes the cooler is uniformly increased by the controller of the vehicle, the charging cable and/or the connector may fail under circumstances where the cooler is not properly operated.

A main object of the present disclosure is to properly protect the charging connector and the charging cable regardless of a condition of the cooler while the battery of an electric vehicle is charged by electric power from the vehicle charging facility.

A vehicle charging facility of the present disclosure is configured to externally charge a battery of an electric vehicle. The vehicle charging facility includes a charging cable, an electric power equipment, a cooler, and a controller. The charging cable includes a charging connector that is plugged into a charging inlet of the electric vehicle. The electric power equipment is configured to supply a charging current to the battery via the charging connector and the charging cable. The cooler is configured to cool the charging connector and the charging cable. The controller is programmed to control the cooler so as to cool the charging connector and the charging cable when the charging current is supplied from the electric power equipment to the battery. Further, the controller is programmed to limit at least one of the charging current and a charging time of the battery based on a temperature of at least one of the charging connector and the charging cable when an abnormality occurs in the cooler.

Another vehicle charging facility of the present disclosure is configured to externally charge a battery of an electric vehicle. The vehicle charging facility includes a charging cable, an electric power equipment, a cooler with a first temperature sensor, a second temperature sensor, and a controller. The charging cable includes a charging connector that is plugged into a charging inlet of the electric vehicle. The electric power equipment is configured to supply a charging current to the battery via the charging connector and the charging cable. The cooler is configured to cool the charging connector and the charging cable, and the first temperature sensor is configured to detect a temperature of at least one of the charging connector and the charging cable. The second temperature sensor is configured to detect a temperature of the electrical power equipment. The controller is programmed to control the cooler so as to cool the charging connector and the charging cable when the charging current is supplied from the electric power equipment to the battery. Further, the controller is programmed to estimate the temperature of at least one of the charging connector and the charging cable based on a detected value of the second temperature sensor when an abnormality occurs in the first temperature sensor, and limit at least one of the charging current and a charging time of the battery based on the estimated temperature.

The vehicle charging facility of the present disclosure enables the charging connector and the charging cable thereof and the charging inlets of the electric vehicle to be properly protected while the battery of the electric vehicle is charged by electric power from the electric power equipment, regardless of the condition of the cooler.

### BRIEF DESCRIPTION OF DRAWINGS

FIG. 1 is a schematic configuration diagram illustrating the vehicle charging facility of the present disclosure;

FIG. 2 is a flowchart showing one example of a routine executed by the controller of the vehicle charging facility of the present disclosure; and

FIG. 3 is a flowchart showing another example of a routine executed by the controller of the vehicle charging facility of the present disclosure.

### DESCRIPTION OF EMBODIMENTS

The following describes some aspects of the present disclosure with reference to drawings.

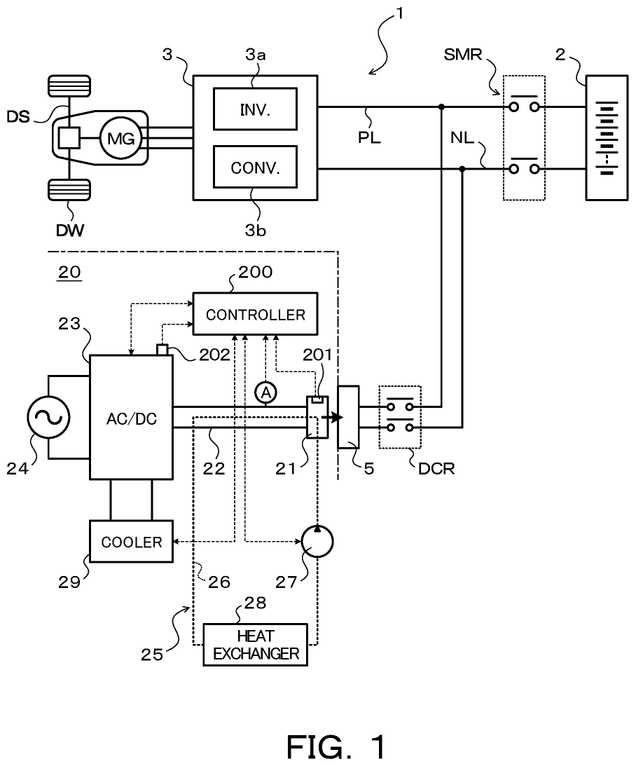

FIG. 1 is a schematic configuration diagram of a vehicle charging facility 20 of the present disclosure. The vehicle charging facility 20 shown in the figure is a so-called quick charging station that enables a battery (high-voltage battery) 2 of an electric vehicle 1 to be charged. The electric vehicle 1 shown in FIG. 1 is a battery electric vehicle (BEV), which includes a system main relay SMR, a power control unit (“PCU”) 3, and a motor generator MG in addition to the battery 2. The electric vehicle 1 may also be a plug-in hybrid vehicle (PHEV).

The battery 2 of the electric vehicle 1 includes a plurality of battery modules (battery stacks) connected in series. Each battery module of the battery 2 includes a plurality of battery cells (not shown) connected in series or parallel. Each battery cell is, for example, a lithium-ion secondary battery or a nickel-metal hydride secondary battery. A positive terminal of battery 2 is connected to a positive side power line PL via a positive relay of the system main relay SMR. A negative terminal of battery 2 is connected to a negative side power line NL via a negative relay of the system main relay SMR.

The PCU 3 is connected to the battery 2 via the positive side power line PL, the negative side power line NL, and the system main relay SMR. The PCU 3 includes an inverter (drive circuit) 3a, a boost converter 3b, and capacitors (not shown) capable of being charged and discharged. The inverter 3a drives the motor generator MG. The boost converter 3b enables electric power from the battery 2 to be boosted and voltage from the motor generator MG side to be stepped down.

The motor generator MG is a synchronous generator motor (three-phase AC motor). The rotor of the motor generator MG is connected to left and right drive wheels DW via a reduction gear, differential gear and drive shafts DS. The motor generator MG is driven by electric power from the PCU 3 (battery 2) and outputs drive torque (driving force) to the drive shafts DS. Further, the motor generator MG outputs regenerative braking torque to the drive shafts DS when braking the electric vehicle 1.

Further, the electric vehicle 1 includes a charging relay DCR and a charging inlet 5 into which a charging connector 21 of the vehicle charging facility 20 is plugged (connected). The charging relay DCR is connected to the positive side power line PL and the negative side power line NL between the system main relay SMR and the PCU 3 via power lines. The charging inlet 5 is installed in a charging lid (not shown) of the electric vehicle 1 and is connected to the charging relay DCR via power lines. This electrically connects the battery 2 to the charging inlet 5 when both the system main relay SMR and the charging relay DCR are closed.

As shown in FIG. 1, the vehicle charging facility 20 includes a charging cable 22 with the charging connector 21, an electric power converter (electric power equipment) 23 to which the charging cable 22 is electrically connected, and a controller 200. The charging cable 22 includes a positive pole side power feed line connected to a positive pole terminal of the charging connector 21, a negative pole side power feed line connected to a negative pole terminal of the charging connector 21, and communication lines connected to signal terminals of the charging connector 21. The electric power converter 23 includes a rectifier circuit, a transformer, a switching circuit, and the like, and converts AC power supplied from an AC power source 24 such as a commercial power source into DC power. When the charging connector 21 is plugged into the charging inlet 5 of the electric vehicle 1, the electric power converter 23 is electrically connected to the charging inlet 5 via the charging cable 22 and the charging connector 21.

Further, the vehicle charging facility 20 includes a first cooler 25 configured to cool the charging connector 21 and the charging cable 22. The first cooler 25 includes a refrigerant passage 26, a refrigerant pump 27, a heat exchanger 28, and a first temperature sensor 201. The refrigerant passage 26 includes passageways formed inside the charging connector 21 and the charging cable 22 (outer skin thereof) and is connected to the discharge port of the refrigerant pump 27 and a refrigerant inlet of the heat exchanger 28. The refrigerant pump 27 sucks coolant (cooling water) from a refrigerant outlet of the heat exchanger 28 and circulates the coolant between the charging connector 21, the charging cable 22 and the heat exchanger 28. The heat exchanger 28 is, for example, an air-cooled heat sink with heat transfer tubes and heat radiation fins. The first temperature sensor 201 detects a temperature Tc of the charging connector 21.

In this embodiment, the coolant is supplied to the charging connector 21 by the refrigerant pump 27, passes through the charging cable 22, and flows into the refrigerant inlet of the heat exchanger 28. This cools the charging connector 21, the charging cable 22, and the charging inlet 5 (portion in contact with the charging connector 21) of the electric vehicle 1 by operating the refrigerant pump 27. The first cooler 25 may be an air-cooled cooler. Further, the first cooler 25 may be a heat pump system or a thermoelectric cooler including a Peltier element.

The vehicle charging facility 20 further includes a second cooler 29, a second temperature sensor 202, a current sensor A, and a voltage sensor (not shown). The second cooler 29 is a liquid-cooled or air-cooled cooler and cools the electric power converter 23. The second temperature sensor 202 detects a temperature (representative temperature) Tp of the electric power converter 23. The current sensor A detects a charging current supplied from the electric power converter 23 to the charging connector 21 (battery 2). The voltage sensor detects voltage supplied from the electric power converter 23 to the charging connector 21.

The controller 200 of the vehicle charging facility 20 includes a computer (not shown) with a CPU, ROM, RAM and the like. When the charging connector 21 is plugged into the charging inlet 5 of the electric vehicle 1 and both the system main relay SMR and the charging relay DCR are closed, the controller 200 controls the electric power converter 23, the first and second coolers 25, 29 based on detected values of the current sensor A, the voltage sensor, the first and second temperature sensors 201, 202 and the like. As a result, the battery 2 of the electric vehicle 1 is charged by the vehicle charging facility 20 that is the electric power (DC power) from the electric power converter 23. Further, during a charging of the battery 2, the charging connector 21, the charging cable 22, the charging inlet 5 of the electric vehicle 1 and the electric power converter 23 are cooled by the first or second coolers 25, 29. The controller 200 also exchanges information with an electronic controller (ECU) of the electric vehicle 1 via the communication lines of the charging cable 22 when the charging connector 21 is plugged into the charging inlet 5 of the electric vehicle 1. Further, the controller 200 determines at predetermined intervals whether or not the first cooler 25, second cooler 29, first temperature sensor 201, and second temperature sensor 202 are abnormal when the vehicle charging facility 20 is in standby mode or while the battery 2 is being charged.

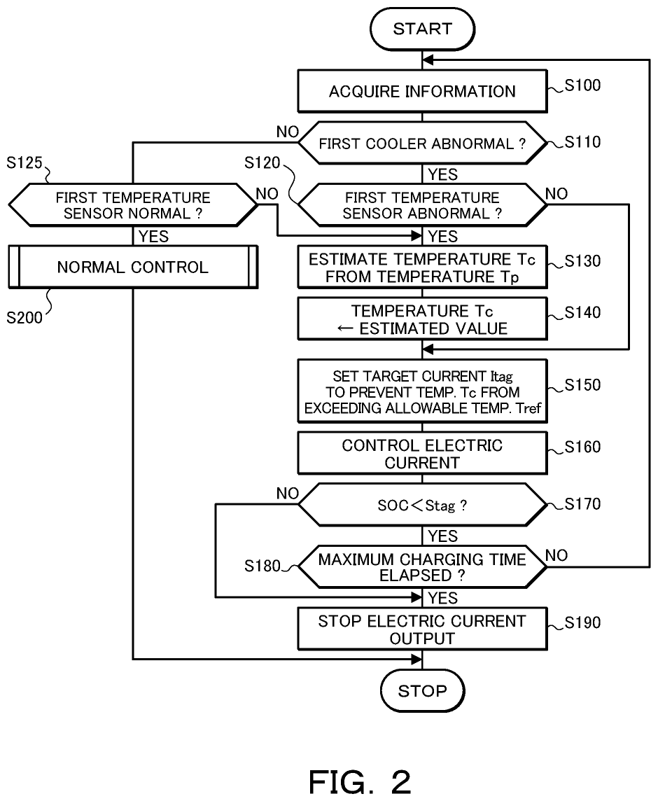

FIG. 2 is a flowchart showing an example of a routine executed by the controller when the battery 2 of the electric vehicle 1 is charged by the electric power from the vehicle charging facility 20.

When a timing for execution of the routine in FIG. 2 arrives, the controller 200 acquires necessary information, such as the detected values of the current sensor A, the voltage sensor, the first and second temperature sensors 201, 202, abnormality determination results for the first cooler 25 and the first temperature sensor 201, and SOC of the battery 2 sent from the ECU of the electric vehicle 1 (step S100). Next, the controller 200 determines whether or not the abnormality occurs in the first cooler 25 based on the abnormality determination result acquired in step S100 (step S110). When an abnormality is occurring in the first cooler 25 (step S110: YES), the controller 200 determines whether an abnormality is occurring in the first temperature sensor 201 based on the abnormality determination result acquired in step S100 (step S120).

When an abnormality occurs in the first temperature sensor 201 (step S120: YES), the controller 200 estimates the temperature Tc of the charging connector 21 based on the detected value of the second temperature sensor 202 acquired in step S100, that is the temperature Tp of the electric power converter 23 (step S130). In step S130, the controller 200 acquires the temperature of the charging connector 21 corresponding to the detected value of the second temperature sensor 202 acquired in step S100 from a temperature estimation map (not shown) prepared in advance. The temperature estimation map is adapted through experiments and analysis so as to define a correlation between the temperature Tp of the electric power converter 23 and the temperature Tc of the charging connector 21 during the charging of the battery 2. Further, the controller 200 sets the estimated temperature of the charging connector 21 (estimated value) in step S130 to the temperature Tc of the charging connector 21 (step S140). When the first temperature sensor 201 is normal (step S120: NO), steps S130 and S140 are skipped, and the detected value (actual measured value) of the first temperature sensor 201 acquired in step S100 is used as the temperature Tc of the charging connector 21 as is.

After the process of step S120 or S140, the controller 200 sets a target current Itag of the charging current that prevents the temperature Tc of the charging connector 21, which is actually measured or estimated, from exceeding an allowable temperature Tref, which is predetermined based on heat resistance performance of the charging connector 21 and the like (step S150). In step S150, the controller 200 acquires the target current Itag corresponding to the temperature Tc (detected value or estimated value) of the charging connector 21 from a target current setting map (not shown) prepared in advance. The target current setting map is adapted through experiments and analysis to define a correlation between the temperature Tc of the charging connector 21 during the charging of the battery 2 and current (target current Itag) to maintain the temperature of the charging connector 21 equal to or less than the allowable temperature Tref. In this embodiment, the target current setting map decreases the target current Itag as the temperature Tc of the charging connector 21 increases.

Then, the controller 200 controls the electric power converter 23 such that the current (output current) from the electric power converter 23 detected by the current sensor A becomes the target current Itag set in step S150 (step S160). Further, the controller 200 determines whether the SOC of the battery 2 acquired in step S100 is less than a predetermined target value Stag (for example, a value of about 70-80%) (step S170). When the SOC of the battery 2 is less than the target value Stag (step S170: YES), the controller 200 determines whether a predetermined maximum charging time tmax (for example, about 30 minutes) has elapsed from a start of the charging of the battery 2 (step S180). When the maximum charging time tmax has not elapsed from the start of the charging of the battery 2 (step S180: NO), the controller 200 repeats the processes from and after step S100 at predetermined intervals.

When the SOC of the battery 2 reaches the target value Stag (step S170: NO), the controller 200 stops the output of the current from the electric power converter 23 (step S190) and terminates the charging of the battery 2. Further, when the maximum charging time tmax has elapsed from the start of the charging of the battery 2 (step S180: YES), the controller 200 stops the output of the current from the electric power converter 23 (step S190) regardless of the SOC of the battery 2 and terminates the charging of the battery 2.

On the other hand, when the first cooler 25 is normal (step S110: NO), the controller 200 determines whether the first temperature sensor 201 is normal (step S125). When the first temperature sensor 201 is abnormal (step S125: NO), the controller 200 executes the processes in steps S130-S160 and terminates the charging of the battery 2 according to a determination result in step S170 or S180. When the first temperature sensor 201 is normal (step S125: YES), the controller 200 controls the electric power converter 23 and the like in accordance with a predetermined normal procedure (step S200) to complete the charging of the battery 2. In step S200, the controller 200 controls the refrigerant pump 27 of the first cooler 25 such that the temperature Tc of the charging connector 21 detected by the first temperature sensor 201 becomes, for example, a target temperature lower than the above allowable temperature Tref. As a result, the charging connector 21, the charging cable 22, and the charging inlet 5 of the electric vehicle 1 are cooled by the first cooler 25 while the current is supplied from the electric power converter 23 to the battery 2.

As described above, when the abnormality occurs in the first cooler 25 (step S110: YES), the controller 200 of the vehicle charging facility 20 limits the charging current from the electric power converter 23 to the target current Itag corresponding to the temperature Tc of the charging connector 21 (step S150) such that the temperature Tc (detected value or estimated value) does not exceed the predetermined allowable temperature (threshold value) Tref. When the maximum charging time tmax has elapsed from the start of the charging of the battery 2, the controller 200 terminates the charging of the battery 2 regardless of the SOC of the battery 2 (step S180: YES, S190). This suppresses a temperature rise of the charging connector 21, the charging cable 22, and the charging inlet 5 of the electric vehicle 1 while the battery 2 is charged by the electric power from the electric power converter 23, even if the abnormality occurs in the first cooler 25.

Further, when the abnormality occurs in the first temperature sensor 201 (step S125: NO), the controller 200 of the vehicle charging facility 20 limits the charging current from the electric power converter 23 to the target current Itag corresponding to the temperature Tc of the charging connector 21 such that the temperature Tc estimated from the temperature Tp of the electric power converter 23 does not exceed the allowable temperature Tref, regardless of a condition of the first cooler 25 (step S150). When the predetermined maximum charging time tmax has elapsed from the start of the charging of the battery 2, the controller 200 terminates the charging of the battery 2 regardless of the SOC of the battery 2 (step S180: YES, S190). This suppresses the temperature rise of the charging connector 21, the charging cable 22, and the charging inlet 5 of the electric vehicle 1 while the battery 2 is charged by the electric power from the electric power converter 23, even if the abnormality occurs in the first temperature sensor 201 of the first cooler 25.

In the vehicle charging facility 20, when the first cooler 25 and the first temperature sensor 201 are normal (step S110: NO, S125: YES), the charging connector 21 and charging cable 22 are cooled by the first cooler 25 (step S200) while the charging current is supplied from the electric power converter 23 to the battery 2 of the electric vehicle 1. This suppresses the temperature rise of the charging connector 21, the charging cable 22, and the charging inlet 5 of the electric vehicle 1 while the battery 2 is charged by the electric power from the electric power converter 23.

As a result, the charging connector 21 and charging cable 22 of the vehicle charging facility 20 and the charging inlet 5 of the electric vehicle 1 are properly protected while the battery 2 of the electric vehicle 1 is charged by the electric power from the electric power converter 23, regardless of the condition of the first cooler 25 with the first temperature sensor 201. In step S180 of FIG. 2, the controller 200 may determine whether an appropriate charging time set according to the temperature Tc (detected or estimated) of the charging connector 21 has elapsed from the start of charging the battery 2. In step S150 of FIG. 2, the target current Itag may be set based on the detected or estimated temperature of the charging cable 22 or the detected or estimated temperature of the charging connector 21 and the charging cable 22 instead of the detected or estimated temperature Tc of the charging connector 21.

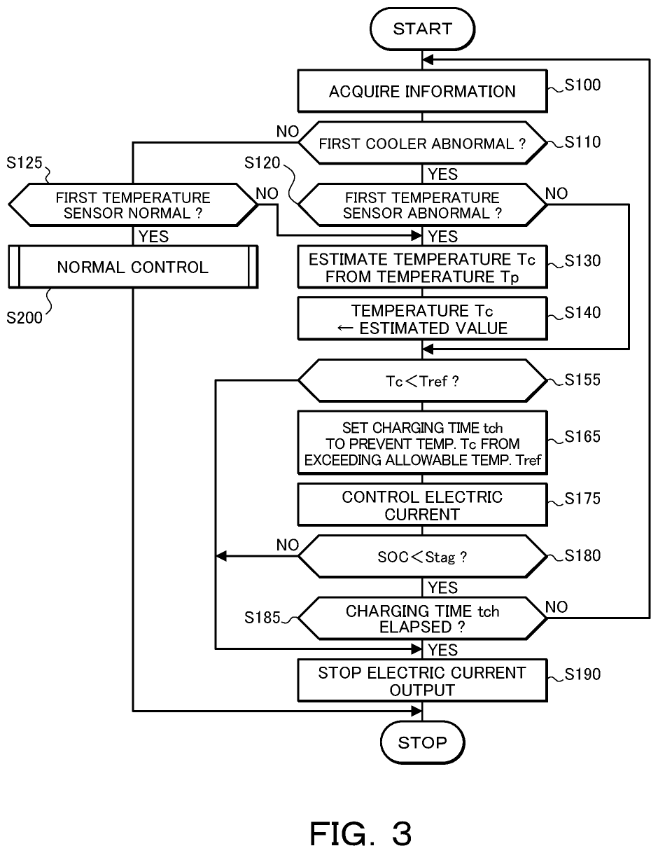

FIG. 3 is a flowchart showing another example of a routine executed by the controller 200 when the battery 2 of the electric vehicle 1 is charged by the electric power from the vehicle charging facility 20. Among the processes (steps) in the routine shown in FIG. 3, the same processes as those shown in FIG. 2 are marked with the same reference numerals, and redundant explanations are omitted.

When the controller 200 executes the routine in FIG. 3 and determines that the abnormality is occurring in the first cooler 25 (step S110: YES), the controller 200 determines whether the temperature Tc of the charging connector 21, which is either the detection value (actual measurement value) of the first temperature sensor 201 or the temperature of the charging connector 21 estimated based on the temperature Tp of the electric power converter 23 (estimated value), is less than the above allowable temperature Tref (step S155). When the controller 200 executes the routine in FIG. 3 and determines that the first temperature sensor 201 is abnormal (step S125: NO), the controller 200 determines whether or not the temperature Tc of the charging connector 21, which is estimated based on the temperature Tp of the electric power converter 23, is less than the allowable temperature Tref (step S155).

When the temperature Tc of the charging connector 21 is less than the allowable temperature Tref (step S155: YES), the controller 200 sets a charging time tch (elapsed time from the start of the charging of the battery 2) that prevents the actually measured or estimated temperature Tc of the charging connector 21 from exceeding the above allowable temperature Tref (Step S165). In step S165, the controller 200 acquires the charging time tch corresponding to the temperature Tc (detected value or estimated value) of the charging connector 21 from a charging time setting map (not shown) prepared in advance. The charging time setting map is adapted through experiments and analysis to define a correlation between the temperature Tc of the charging connector 21 during the charging of the battery 2 and the charging time tch to maintain the temperature of the charging connector 21 equal to or less than the allowable temperature Tref. In this embodiment, the charging time setting map shortens the charging time tch as the temperature Tc of the charging connector 21 increases. The charging time tch set in step S165 is shorter than the above maximum charging time tmax.

Then, the controller 200 controls the electric power converter 23 such that the current detected by the current sensor A becomes a predetermined current (constant value) (step S175). Further, the controller 200 determines whether the SOC of the battery 2 acquired in step S100 is less than the predetermined target value Stag (step S180). When the SOC of the battery 2 is less than the target value Stag (step S180: YES), the controller 200 determines whether the charging time tch set in step S165 has elapsed from the start of the charging of the battery 2 (step S185). When the charging time tch has not elapsed from the start of the charging of the battery 2 (step S185: NO), the controller 200 repeats the processes from and after step S100 at predetermined intervals.

When the temperature Tc of the charging connector 21 is equal to or more than the allowable temperature Tref (step S155: NO), the controller 200 stops the output of current from the electric power converter 23 (step S190) regardless of the SOC of the battery 2 and terminates the charging of the battery 2. Further, when the SOC of the battery 2 reaches the target value Stag (step S180: NO), the controller 200 stops the output of the current from the electric power converter 23 (step S190) and terminates the charging of the battery 2. When the charging time tch has elapsed from the start of the charging of the battery 2 (step S185: YES), the controller 200 stops the output of the current from the electric power converter 23 (step S190) and terminates the charging of the battery 2, regardless of the SOC of the battery 2.

As described above, the controller 200 which executes the routine in FIG. 3 sets the charging time tch such that the temperature Tc (detected or estimated value) of the charging connector 21 does not exceed the predetermined allowable temperature (threshold value) Tref (Step S165) when the abnormality occurs in the first cooler 25 (step S110: YES). When the temperature Tc of the charging connector 21 reaches the allowable temperature Tref, the controller 200 terminates the charging of the battery 2 regardless of the SOC of the battery 2 and an elapse of the charging time tch (step S155: NO, S190). This suppresses the temperature rise of the charging connector 21, the charging cable 22, and the charging inlet 5 of the electric vehicle 1 while the battery 2 is charged by the electric power from the electric power converter 23, even if the abnormality occurs in the first cooler 25.

Further, when the abnormality occurs in the first temperature sensor 201 (step S125: NO), the controller 200 which executes the routine in FIG. 3 sets the charging time tch such that the temperature Tc of the charging connector 21, which is estimated from the temperature Tp of the electric power converter 23, does not exceed the allowable temperature Tref regardless of the status of the first cooler 25 (step S165). When the temperature Tc of the charging connector 21 reaches the allowable temperature Tref, the controller 200 terminates the charging of the battery 2 regardless of the SOC of the battery 2 and the elapse of the charging time tch (step S155: NO, S190). This suppresses the temperature rise of the charging connector 21, the charging cable 22, and the charging inlet 5 of the electric vehicle 1 while the battery 2 is charged by the electric power from the electric power converter 23, even if the abnormality occurs in the first temperature sensor 201 of the first cooler 25.

In the vehicle charging facility 20 to which the routine in FIG. 3 is applied, when the first cooler 25 and the first temperature sensor 201 are normal (steps S110: NO, S125: YES), the charging connector 21 and charging cable 22 are cooled by the first cooler 25 (step S200) while the charging current is supplied from the electric power converter 23 to the battery 2 of the electric vehicle 1. This suppresses the temperature rise of the charging connector 21, the charging cable 22, and the charging inlet 5 of the electric vehicle 1 while the battery 2 is charged by the electric power from the electric power converter 23.

As a result, the charging connector 21 and charging cable 22 of the vehicle charging facility 20 to which the routine in FIG. 3 is applied and the charging inlet 5 of the electric vehicle 1 are properly protected while the battery 2 of the electric vehicle 1 is charged by the electric power from the electric power converter 23, regardless of the condition of the first cooler 25 with the first temperature sensor 201. In step S175 of FIG. 3, the controller 200 may control the electric power converter 23 so as to output an appropriate current set according to the temperature Tc (detected value or estimated value) of the charging connector 21. In steps S155 and S165 of FIG. 3, the detected or estimated temperature of the charging cable 22 or the detected or estimated temperature of the charging connector 21 and the charging cable 22 may be used instead of the detected or estimated temperature Tc of the charging connector 21.

As has been described above, the vehicle charging facility (20) of the present disclosure is configured to externally charge the battery (2) of the electric vehicle (1). The vehicle charging facility (20) includes the charging cable (22), the electric power equipment (23), the cooler (24), and the controller (200). The charging cable (22) includes the charging connector (21) that is plugged into the charging inlet (5) of the electric vehicle (1). The electric power equipment (23) is configured to supply the charging current to the battery (2) via the charging connector (21) and the charging cable (22). The cooler (25) is configured to cool the charging connector (21) and the charging cable (22). The controller (200) is programmed to control the cooler (25) so as to cool the charging connector (21) and the charging cable (22) when the charging current is supplied from the electric power equipment (23) to the battery (2) (S200). Further, the controller (200) is programmed to limit at least one of the charging current and the charging time of the battery (2) based on the temperature of at least one of the charging connector (21) and the charging cable (22) (S150, S165) when the abnormality occurs in the cooler (25) (S110: YES).

When the cooler is normal, the vehicle charging facility of the present disclosure cools the charging connector and the charging cable by the cooler while the battery is charged by electric power from the electric power equipment so as to suppress the temperature rise of the charging connector, the charging cable and the charging inlet. Further, when the abnormality occurs in the cooler, the vehicle charging facility limits at least one of the charging current and the charging time of the battery based on the temperature of at least one of the charging connector and the charging cable so as to suppress the temperature rise of the charging connector, the charging cable and the charging inlet. As a result, the charging connector and the charging cable of the vehicle charging facility and the charging inlet of the electric vehicle are properly protected regardless of the condition of the cooler.

The controller (200) may be programmed to limit at least one of the charging current and the charging time of the battery (2) such that the temperature of at least one of the charging connector (21) and the charging cable (22) does not exceed a predetermined threshold (Tref) (S150, S165) when the abnormality occurs in the cooler (25) (S110: YES).

This enables the charging connector and the charging cable of the vehicle charging facility and the charging inlet of the electric vehicle to be satisfactory protected when the charging connector and the charging cable are not properly cooled by the cooler during battery charging.

The controller (200) may be programmed to set the target current (Itag) of the charging current such that the temperature of at least one of the charging connector (21) and the charging cable (22) does not exceed the threshold (Tref) when the abnormality occurs in the cooler (25) (S150). The controller (200) may be programmed to control the electric power equipment (23) so as to output the target current (Itag) (S160), and terminate the charging of the battery (2) when the predetermined time (tmax) is elapsed from the start of the charging of the battery (23) (S180: YES, S190).

The controller (200) may be programmed to set the charging time (tch) such that the temperature (Tc) of at least one of the charging connector (21) and the charging cable (22) does not exceed the threshold (Tref) (S165) when the abnormality occurs in the cooler (25) (S110: YES). The controller (200) may be programmed to terminate the charging of the battery (2) (S190) when the charging time (tch) is elapsed from the start of the charging of the battery (2) (S185: YES), or when the temperature (Tc) of at least one of the charging connector (21) and the charging cable (22) reaches the threshold (Tref) (S155: NO).

Another vehicle charging facility (20) of the present disclosure is configured to externally charge the battery (2) of the electric vehicle (1). The vehicle charging facility (20) includes the charging cable (22), the electric power equipment (23), the cooler (25) with the first temperature sensor (201), the second temperature sensor (202), and the controller (200). The charging cable (22) includes the charging connector (21) that is plugged into the charging inlet (5) of the electric vehicle (1). The electric power equipment (23) is configured to supply the charging current to the battery (2) via the charging connector (21) and the charging cable (22). The cooler (25) is configured to cool the charging connector (21) and the charging cable (22), and the first temperature sensor (201) is configured to detect the temperature of at least one of the charging connector (21) and the charging cable (22). The second temperature sensor (202) is configured to detect the temperature of the electrical power equipment (23). The controller (200) is programmed to control the cooler (25) so as to cool the charging connector (21) and the charging cable (22) when the charging current is supplied from the electric power equipment (23) to the battery (2) (S200). Further, the controller (200) is programmed to estimate the temperature of at least one of the charging connector (21) and the charging cable (22) based on the detected value of the second temperature sensor (202) (S130, S140) when the abnormality occurs in the first temperature sensor (201) (S125: NO), and limit at least one of the charging current and the charging time of the battery (2) based on the estimated temperature of at least one of the charging connector (21) and the charging cable (22) (S150, S165).

When the cooler is normal, another vehicle charging facility of the present disclosure cools the charging connector and the charging cable by the cooler while the battery is charged by electric power from the electric power equipment so as to suppress the temperature rise of the charging connector, the charging cable and the charging inlet. Further, when the abnormality occurs in the cooler, the vehicle charging facility limits at least one of the charging current and the charging time of the battery based on the temperature of at least one of the charging connector and the charging cable estimated from the detected value of the second temperature sensor so as to suppress the temperature rise of the charging connector, the charging cable and the charging inlet. As a result, the charging connector and the charging cable of the vehicle charging facility and the charging inlet of the electric vehicle are properly protected regardless of the condition of the cooler with the first temperature sensor.

The disclosure is not limited to the above embodiments in any sense but may be changed, altered or modified in various ways within the scope of extension of the disclosure. Additionally, the embodiments described above are only concrete examples of some aspect of the disclosure described in Summary and are not intended to limit the elements of the disclosure described in Summary.

### INDUSTRIAL APPLICABILITY

The technique of the present disclosure is applicable to, for example, the manufacturing industry of the vehicle charging facility and the manufacturing industry of the vehicle.

1. A vehicle charging facility configured to externally charges a battery of an electric vehicle, the vehicle charging facility comprising:
a charging cable with a charging connector that is plugged into a charging inlet of the electric vehicle;
an electric power equipment configured to supply a charging current to the battery via the charging connector and the charging cable;
a cooler configured to cool the charging connector and the charging cable; and
a controller programmed to
control the cooler so as to cool the charging connector and the charging cable when the charging current is supplied from the electric power equipment to the battery, and
limit at least one of the charging current and a charging time of the battery based on a temperature of at least one of the charging connector and the charging cable when an abnormality occurs in the cooler.

2. The vehicle charging facility according to claim 1,
wherein the controller is programmed to limit at least one of the charging current and the charging time of the battery such that the temperature of at least one of the charging connector and the charging cable does not exceed a predetermined threshold when the abnormality occurs in the cooler.

3. The vehicle charging facility according to claim 2,
wherein, the controller is programmed to set a target current of the charging current such that the temperature of at least one of the charging connector and the charging cable does not exceed the threshold when the abnormality occurs in the cooler, and
wherein the controller is programmed to control the electric power equipment so as to output the target current, and terminate a charging of the battery when a predetermined time is elapsed from a start of the charging of the battery.

4. The vehicle charging facility according to claim 2,
wherein, the controller is programmed to set the charging time such that the temperature of at least one of the charging connector and the charging cable does not exceed the threshold when the abnormality occurs in the cooler, and
wherein the controller is programmed to terminate a charging of the battery when the charging time is elapsed from a start of the charging of the battery, or when the temperature of at least one of the charging connector and the charging cable reaches the threshold.

5. A vehicle charging facility configured to externally charges a battery of an electric vehicle, the vehicle charging facility comprising:
a charging cable with a charging connector that is plugged into a charging inlet of the electric vehicle;
an electric power equipment configured to supply a charging current to the battery via the charging connector and the charging cable;
a cooler configured to cool the charging connector and the charging cable, and include a first temperature sensor configured to detect the temperature of at least one of the charging connector and the charging cable;
a second temperature sensor configured to detect a temperature of the electrical power equipment; and
a controller programmed to
control the cooler so as to cool the charging connector and the charging cable when the charging current is supplied from the electric power equipment to the battery, and
estimate the temperature of at least one of the charging connector and the charging cable based on a detected value of the second temperature sensor when the abnormality occurs in the cooler, and limit at least one of the charging current and a charging time of the battery based on the estimated temperature of at least one of the charging connector and the charging cable.
